(19) United States
(12) Patent Application Publication
(10) Pub. No.: US 2008/0261421 A1
(43) Pub. Date: Oct. 23, 2008

(54) Card Holding Plug Protector

(76) Inventor: William Wiser, Carollton, TX (US)

Correspondence Address: William Wiser, 2309 Bristol Drive, Carollton, TX, 75006, US

(21) Appl. No.: 11/736,567

(22) Filed: Apr. 17, 2007

(51) Int. Cl. H01R 13/443

(52) U.S. Cl. 439/148; 206/39; 40/124.01

(57) ABSTRACT

A card holding plug protector, for example, configured to fit a 110 volt (V) or 220V outlet, has a frame configured to allow the insertion and display of at least one insert, for example, one or more business cards. The plug protector comprises at least one prong configured to fit an electrical outlet, and a frame attached to the prong, wherein the frame is configured to accept at least one insert and comprises a window through which the insert is at least partially visible. The electrical outlet may be a 3-prong or a 4-prong outlet, although the card holding plug protector may not have the same number of prongs as the outlet is configured to accommodate. The window is configured to enable the majority of the insert to be visible when the insert is in the frame.

### TECHNICAL FIELD

The invention relates generally to safety devices, and more particularly, to safety inserts for electrical outlets.

### BACKGROUND

Professional service providers and contractors, such as home inspectors and electricians, often leave business cards at the houses they visit. Typically the cards are left on counter tops, where they are easily discarded or overlooked.

Some homeowners purchase plug protectors for inserting into electrical outlets to prevent accidental electrocution of curious children. The plug protectors are typically plastic and have non-conductive prongs configured to fit snugly into an electrical outlet so that the plug protector does not fall out inadvertently or conduct electricity out of the outlet. The plug protectors fit 110 volt (V), 15 ampere (A) outlets, because such outlets are within reach of small children and many in a typical house are left unused.

### BRIEF SUMMARY

A card holding plug protector, for example, configured to fit a 110 volt (V) or 220V outlet, has a frame configured to allow the insertion and display of at least one insert, for example, one or more business cards. A card holding plug protector comprises at least one non-conductive prong configured to fit an electrical outlet, and a frame attached to the prong, wherein the frame is configured to accept at least one insert and comprises a window through which the insert is at least partially visible. The electrical outlet may be a 3-prong or a 4-prong outlet, although the card holding plug protector may not have the same number of prongs as the outlet is configured to accommodate. The window is configured to enable the majority of the insert to be visible when the insert is in the frame. The card holding plug protector enables displaying an insert such as a business card by inserting the card into a frame of the plug protector and inserting the plug protector into an electrical outlet. In some embodiments, a second insert may be inserted into the frame.

The foregoing has outlined the features and technical advantages of the invention in order that the description that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the invention.

### BRIEF DESCRIPTION OF THE DRAWINGS

For a more complete understanding of the present invention, reference is now made to the following descriptions taken in conjunction with the accompanying drawings, in which:

FIG. 1 shows a prior art plug protector; and

FIG. 2 shows an embodiment of a card holding plug protector.

### DETAILED DESCRIPTION

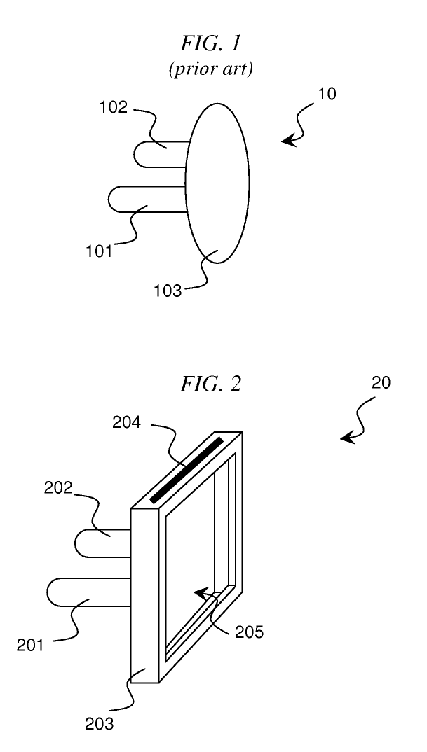

FIG. 1 shows a prior art plug protector 10 comprising prongs 101 and 102 and a shield 103. Prongs 101 and 102 are configured to fit into a standard 110 volt (V), 15 ampere (A) electrical outlet so that shield 103 covers at least part of the electrical outlet.

FIG. 2 shows an embodiment of a card holding plug protector 20. Card holding plug protector 20 comprises non-conductive prongs 201 and 202 attached to a frame 203. In the embodiment illustrated in FIG. 2, card holding plug protector 20 comprises two prongs 201 and 202, although a greater or lesser quantity may be used. Further, prongs 201 and 202, which are illustrated as flat, may be configured in alternate shapes and sizes to fit various electrical outlets, including 110V 15 A outlets, 110V 20 A outlets, 220V 3-prong dryer outlets, 220V 4-prong dryer outlets, 220V electric range outlets, and other electrical outlets for which a plug protector may be desired. In some embodiments, prongs 201 and 202 are made from plastic in order to be non-conductive to electricity. Card holding plug protector 20 does not require same number of prongs as the outlet is configured to accommodate, but may have only enough to enable card holding plug protector 20 to remain in place until it is intentionally removed. Thus, prongs 201 and 202 provide means for temporarily affixing frame 203 to an electrical outlet, because card holding plug protector 20 will remain in place, affixed to the electrical outlet, until card holding plug protector 20 is pulled out.

Frame 203 comprises a slot 204 configured to accept an insert, for example a business card, and a window 205, through which the insert is at least partially visible. In some embodiments, frame 203, slot 204 and window 205 are configured to enable a business card to be inserted into slot 204 and held in place by frame 203, wherein the majority of the face of the business card is visible through window 205. In some embodiments, frame 203 is configured to hold a plurality of business cards, for example a first card visible through window 205 and one or more cards behind the first card. In operation, a service provider, such as a home inspector or electrician inserts one or more business cards into frame 203 of an embodiment of card holding plug protector 20, and inserts card holding plug protector 20 into an electrical outlet, for example a dryer outlet. In some embodiments, frame 203 comprises one or more additional windows 205 to enable the simultaneous, adjacent display of multiple inserts. In some embodiments, windows 205 is sized to enable the simultaneous, display of multiple inserts, for example two business cards horizontally or vertically adjacent.

Although the present invention and its advantages have been described, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A card holding plug protector comprising:
a first non-conductive prong configured to fit an electrical outlet; and
a frame attached to the first prong, wherein the frame is configured to accept at least one insert and comprises a window through which the insert is at least partially visible, and wherein the frame and prong are arranged so that frame shields an electrical outlet when the prong is inserted into an electrical outlet.

2. The plug protector of claim 1 wherein the first non-conductive prong is configured to fit a 3-prong outlet.

3. The plug protector of claim 1 wherein the first non-conductive prong is configured to fit a 4-prong outlet.

4. The plug protector of claim 1 wherein the first prong is configured to fit a 220 volt (V) dryer outlet.

5. The plug protector of claim 1 wherein the first prong is configured to fit a 220 volt (V) electric range outlet.

6. The plug protector of claim 1 wherein the first prong is configured to fit a 110 volt (V) electrical outlet.

7. The plug protector of claim 1 wherein the frame is configured to accept a business card an insert approximately the size of a business card.

8. The plug protector of claim 1 wherein the frame is configured to accept a plurality of inserts approximately the size of a business card.

9. The plug protector of claim 1 wherein the window is configured to enable the majority of the insert to be visible when the insert is in the frame.

10. The plug protector of claim 1 further comprising a second non-conductive prong attached to the frame.

11. The plug protector of claim 1 wherein the first prong comprises a plastic prong.

12. A business card holder comprising:
means for holding at least one card approximately the size of a business card; and
non-conductive means for coupling the means for holding to an electrical outlet.

13. The business card holder of claim 12 wherein the non-conductive means for coupling comprises non-conductive means for coupling to at least one selected from the list consisting of a 110 volt (V) outlet and a 220 volt (V) outlet.

14. A method of displaying a card, the method comprising:
inserting a plug protector into an electrical outlet, the majority of a face of the card is visible through a window of the plug protector.

15. The method of claim 14 further comprising:
inserting the card into a frame of the plug protector.

16. The method of claim 15 further comprising:
inserting a second card into the frame of the plug protector.

17. The method of claim 16 wherein inserting a second card comprises inserting the second card into the frame adjacent to the first card.

18. The method of claim 14 wherein inserting a plug protector into an electrical outlet comprises inserting a non-conductive plug protector.
